(19) United States
(12) Patent Application Publication
(10) Pub. No.: US 2012/0020402 A1
(43) Pub. Date: Jan. 26, 2012

(54) RECEIVER

(75) Inventors: Andreas IBING, Berlin (DE); Holger BOCHE, Berlin (DE)

(73) Assignee: Technische Universitat Berlin

(21) Appl. No.: 12/843,721

(22) Filed: Jul. 26, 2010

(51) Int. Cl. H04B 17/00

(52) U.S. Cl. 375/227

(57) ABSTRACT

An embodiment of the invention relates to a method of determining an optimum sequence of algorithms, wherein each algorithm defines a receiver function of a receiver, which has a plurality of receiver functions and which is adapted to receive bits sent by a transmitter.

The present invention relates to receivers, and more particularly to algorithms defining receiver functions and sequences of such algorithms.

### BACKGROUND OF THE INVENTION

In order to determine an optimum sequence of algorithms for receiver functions, many different approaches are discussed in the literature, from stochastic decoding analysis to convergence prediction of iterative MIMO (multiple inputs, multiple outputs) detection-decoding.

Iterative detection-decoding for coded MIMO transmission is known capable of achieving near-capacity performance [1]. The usage of iterative processing naturally leads to the question of convergence.

Extrinsic information transfer charts (EXIT charts) are widely used for predicting and illustrating convergence of iterative decoding of concatenated codes [2], [3]. The model underlying the chart assumes that the log-likelihood ratios (LLRs) of the transmit bit values are distributed after the symbol demapper according to BPSK transmission over an AWGN (AWGN: additive white Gaussian noise) channel resulting in a 1-parametric conditional Gaussian distribution (conditioned on the transmit bit value). EXIT charts have also been used to model convergence of iterative MIMO detection-decoding. In document [4] they are applied to optimize irregular repeat accumulate codes for MIMO transmission and iterative receiver processing. An optimization of Turbo coded space-time block code transmission based on EXIT charts is presented in [5]. Documents [6, 7] uses EXIT charts to analyse and optimize MIMO transmission with low-density parity-check codes.

### OBJECTIVE OF THE PRESENT INVENTION

An objective of the present invention is to provide a method of determining an optimum sequence of algorithms, wherein each algorithm defines a receiver function of a receiver.

A further objective of the present invention is to provide a method for manufacturing a receiver, wherein an optimum sequence of algorithms is determined and implemented in receiver hardware and/or software.

Another objective of the present invention is to provide a method for simulating sequences of algorithms in order to determine an optimum sequence.

### BRIEF SUMMARY OF THE INVENTION

An embodiment of the invention relates to a method of determining an optimum sequence of algorithms, each algorithm defining a receiver function of a receiver, which has a plurality of receiver functions and which is adapted to receive bits sent by a transmitter, the method comprising the steps of:

(a) for each receiver function, picking an algorithm out of a predefined group of algorithms available for the respective receiver function, and virtually combining predefined models of the picked algorithms in order to model the receiver, wherein each predefined model is capable of mapping at least one input probability density to at least one output probability density, and wherein said combined models form a sequence of model algorithms;

(b) determining an input probability density based on a predefined signal-to-noise ratio, said input probability density indicating the probability density of values received by the receiver at the predefined signal-to-noise ratio;

(c) inputting the input probability density to said sequence of model algorithms;

(d) determining the output probability density at the output of said sequence of model algorithms, said output probability density indicating the bit density of the bits sent by the transmitter;

(e) determining the bit-error rate of the receiver for said sequence of model algorithms based on said output probability density;

(f) repeating steps (a)-(e) for all algorithms comprised by said predefined groups of algorithms for all receiver functions; and

(g) determining the optimum sequence of algorithms taking the bit-error rates of the sequences of model algorithms into account.

An advantage of this embodiment of the invention is that the optimum sequence of algorithms for a specific receiver may be determined based on predefined models of algorithms, only. Instead of carrying out a complete simulation of each algorithm and each sequence of algorithms in its entirety, the embodiment of the invention considers algorithm models which provide limited functionality and which are preferably merely capable of mapping input probability densities to output probability densities like the algorithms they model. As such, an optimum sequence of algorithms may be found faster and with less simulation effort than on the basis of a complete simulation of all aspects of each algorithm.

According to a preferred embodiment a total receiver complexity value is determined by adding algorithm complexity values of all algorithms picked in step (a), wherein in step (g), the total receiver complexity values of the picked algorithms are taken into account for determining the optimum set of algorithms.

Further, the algorithms picked in step (a) may be combined to generate a preliminary sequence of algorithms; and a delay time may be determined for each preliminary sequence of algorithms; and in step (g) the step of determining the optimum set of algorithms may further take the delay time of each preliminary sequence of algorithms into account.

Furthermore, a set of signal-to-noise ratios may be predefined. Then, steps (a)-(g) may be repeated for all signal-to-noise ratios of said set of signal-to-noise ratios, and the optimum sequence of algorithms may be determined taking at least the signal-to-noise ratios and the respective bit-error rates into account.

Preferably, groups of algorithms are taken into account for at least one of the following receiver functions: decoding, mapping, demapping, and channel estimation.

The step of forming said sequence of model algorithms may include combing the model algorithms in a parallel and/or a serial fashion.

According to a further preferred embodiment, the input and output probability densities may each be defined by a mean value and a variance of a 2-parametric Gaussian density function. A 2-parametric Gaussian density may be used to model bit densities by describing mean and variance of the density of their log-likelihood ratios or log-probability ratios conditioned on the transmit bit value.

A 2-parametric Gaussian density may be used to describe the probability density of complex random variables in channel estimation and estimation of transmit symbols by determining mean value and variance.

The model of an algorithm as mapping from input probability densities to output probability densities may be obtained as analytic formula or by Monte-Carlo simulation of this algorithm or semi-analytically.

The probability density of the received values as ‘evidence’ in dependence on SNR (signal to noise ratio), as input to an algorithm sequence, may also be determined as analytic formula or by Monte-Carlo simulation using a channel model, or semi-analytically.

Preferably, the model of at least one algorithm of at least one receiver function accounts for MIMO (multiple input-multiple output) reception. In particular, the model of at least one demapping algorithm, at least one channel estimation algorithm, and/or at least one mapping algorithm may account for MIMO reception.

According to a further preferred embodiment, an individual name may be assigned to each possible combination of receiver function and algorithm/algorithm model. Then, the sequence of model algorithms may be defined by a vector comprising the names as vector elements, and the search for determining the optimum sequence may be based on said vectors.

Each name preferably forms a word of a description language. The description language is preferably regular.

The search space for determining the optimum sequence of algorithms may be defined by a plurality of operations applied to the names and/or vectors.

Furthermore, the optimum sequence of algorithms may be determined taking at least two users into account, wherein an individual signal-to-noise ratio is assigned to each user and wherein at least one receiver function considers the individual signal-to-noise ratios of the at least two users.

A further embodiment of the present invention relates to a method for manufacturing a receiver
wherein an optimum sequence of algorithms is determined, each algorithm defining a receiver function of a receiver, which has a plurality of receiver functions and which is adapted to receive bits sent by a transmitter;
the algorithms of the optimum sequence are assigned to one or more processors; and
the algorithms of the optimum sequence are implemented in receiver hardware and/or receiver software.

Preferably the step of determining the optimum sequence of algorithms comprises the steps of:

(a) for each receiver function, picking an algorithm out of a predefined group of algorithms available for the respective receiver function, and virtually combining predefined models of the picked algorithms in order to model the receiver, wherein each predefined model is capable of mapping at least one input probability density to at least one output probability density, and wherein said combined models form a sequence of model algorithms;

(b) determining an input probability density based on a predefined signal-to-noise ratio, said input probability density indicating the probability density of values received by the receiver at the predefined signal-to-noise ratio;

(c) inputting the input probability density to said sequence of model algorithms;

(d) determining the output probability density at the output of said sequence of model algorithms, said output probability density indicating the bit density of the bits sent by the transmitter;

(e) determining the bit-error rate of the receiver for said sequence of model algorithms based on said output probability density;

(f) repeating steps (a)-(e) for all algorithms comprised by said predefined groups of algorithms for all receiver functions; and

(g) determining the optimum sequence of algorithms taking the bit-error rates of the sequences of model algorithms into account.

According to a further preferred embodiment a total receiver delay time value may be determined based on the processing times of the algorithms during processing by said one or more processors. This total receiver delay time value resulting from the picked algorithms may also be taken into account for determining the optimum set of algorithms.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended figures and tables. Understanding that these figures and tables depict only typical embodiments of the invention and are therefore not to be considered to be limiting of its scope, the invention will be described and explained with additional specificity and detail by the use of the accompanying drawings in which

FIG. 1 shows a factor graph for decoding of Turbo coded MIMO transmission, wherein the variable nodes (information bits u, parity bits c₁, c₂) are vector-valued;

FIG. 2 shows a LLR (log likelihood ratio) conditional probability density function for 4×4 QPSK (Quadrature Phase Shift Keying) MIMO transmission with uncorrelated Rayleigh fading and max-log-APP (a posteriori probability) demapping, wherein the corresponding conditional density according to the 1-parametric Gaussian model is shown: both densities have the same MI (mutual information) with the transmit bits;

FIG. 3 shows a for the Rayleigh fading MIMO channel, wherein EXIT chart based prediction produces a large error; in FIG. 3 (4×4 QPSK, max-log-APP demapper) the prediction error corresponds to more than 1 dB channel SNR, and the simulation uses maximum LTE (Long Term Evolution) packet length of 6144 information bits;

FIG. 4 shows mapping LLR distribution parameters to mutual information, wherein the mutual information is determined by the ratio q of mean value and standard deviation, wherein ‘Full’ MI corresponds to BER (bit error rate) smaller 10⁻⁴ achieved for q>3.7, and wherein the 1-parametric model is included as special case and shown as curve in the MI surface;

FIG. 5 shows a LLR probability density for positive transmit bits from the example in FIG. 2, and the corresponding 2-parametric Gaussian density, the two densities having the same mean and variance, but different MI (LLRs: 0.39; Gauss: 0.34);

FIG. 6 shows a verifying MI prediction accuracy for predicted and measured MI for the three different schedules (packet length 6144 information bits);

FIG. 7 shows a predicted and measured bit error rate for one example schedule, using very long packets (106 bits), wherein the curves for smaller packet length (6144 information bits) differ only insignificantly;

FIG. 8 shows a factor graph of joint probability density, wherein variable nodes are circles, factor nodes are squares, and ‘Evidence’ y is shaded, and wherein all variable nodes are vectors, and H^{(t)} are matrices;

FIG. 9 shows MU (multi user)-MIMO with joint MIMO demapping and separate decoding;

FIG. 10 shows a table of a theoretically achievable cycle count for elementary operations on 128 bit wide Cell SPU (SPU: Synergistic processor unit) and SIMD (SIMD: single instruction, multiple data) parallel implementation;

FIG. 11 shows an example search graph specifying the receiver design space (without channel estimation);

FIG. 12 shows a computational effort of the considered signal processing blocks on Cell SPU; and

FIG. 13 shows results for 4×4 QPSK (Quadrature Phase Shift Keying).

### DETAILED DESCRIPTION OF THE PREFERRED EMBODIMENT

The preferred embodiment of the present invention will be best understood by reference to the drawings, wherein identical or comparable parts are designated by the same reference signs throughout.

It will be readily understood that the present invention, as generally described herein, could vary in a wide range. Thus, the following more detailed description of the exemplary embodiments of the present invention, is not intended to limit the scope of the invention, as claimed, but is merely representative of presently preferred embodiments of the invention.

System model

Considering standard processing at the transmitter for Turbo coded MIMO transmission: the information bit vector u to transmit is transformed into code word b by adding code bits c₁ of the first constituent encoder and code bits c₂ of the second constituent encoder. bᵢ is written for a single bit of the bit vector b at position i. At time instance t the symbol vector x^{(t)} is transmitted (as part of x) over channel matrix H^{(t)}:

y^{(t)}=H^{(t)}·x^{(t)}(b^{(t)})+n^{(t)}. (1)

Concerning channel estimation, knowledge of channel matrices H^{(t)} and noise variance at the receiver is assumed as channel estimation is known per se.

Optimum receiver performance means finding the information word with highest a posteriori probability given the received vectors and channel knowledge:

$$\hat{u} = arg {max}_{u} P ( u \vert y , H ) . \qquad ( 2 )$$

Since this joint detection and decoding is too complex for practical implementation, the practical approach is an iterative approximation of the information bit a posteriori probabilities

P(uᵢ|y, H) (3)

by local computation. This is an application of the mathematical framework of Bayesian Belief Propagation [8] with 2 loops. Conditional independencies of variables are exploited by factorizing the joint probability density function into factors which depend only on subsets of the variables. In this case it is:

$$\begin{matrix}P ( u , y , H ) = {f}_{Det} ( u , {c}_{1} , {c}_{2} , y , H ) {f}_{Dec 1} ( u , {c}_{1} ) \cdot \cdot \\ {f}_{Dec 2} ( u , {c}_{2} ) \\ = ( {\prod }_{t} \tilde{{f}_{Det}} ( {b}^{( t )} , {y}^{( t )} , {H}^{( t )} ) ) \cdot \cdot \\ {f}_{Dec 1} ( u , {c}_{1} ) {f}_{Dec 2} ( u , {c}_{2} ) .\end{matrix} \qquad ( 4 )$$

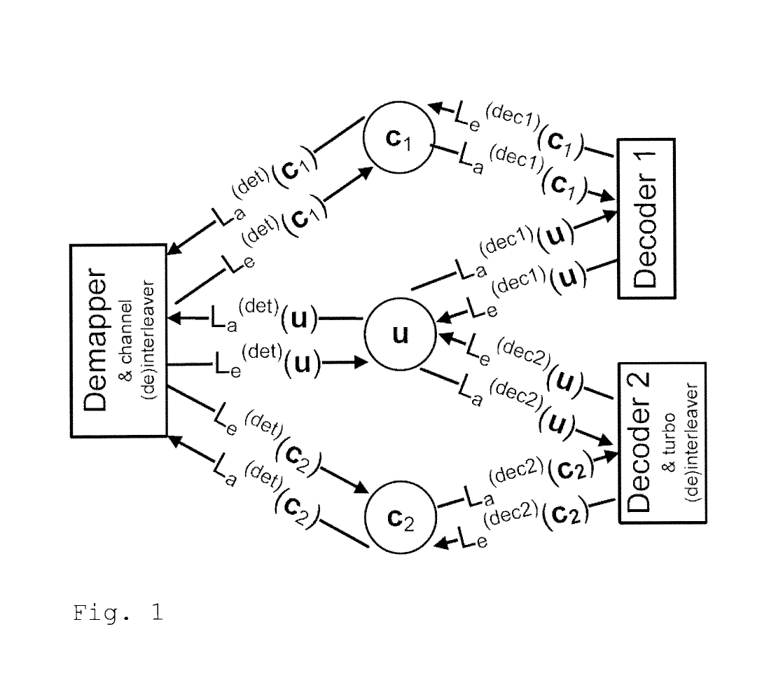

The factors are one MIMO demapper for each time instance, and the two constituent decoders. The corresponding receiver architecture is shown in FIG. 1 as factor graph (factor graphs are described in [9], [10]). Factor nodes perform a posteriori probability (APP) computation on subsets of variables, where the involved variables are depicted as variable nodes neighbouring to the factor node. A factor node outputs only the information increment gained by computation, which is often called extrinsic information [2]. To avoid the effort for normalizing probability densities and to further reduce computational effort, implementation uses log-likelihood ratios (LLRs) instead of bit probabilities themselves (multiplications are turned into additions in the log domain). The messages passed in FIG. 1 are therefore vectors of LLRs. Lₐ denotes a priori LLR, Lₚ a posteriori LLR. A factor node computes a posteriori LLRs, but outputs only the extrinsic LLRs Lₑ=Lₚ−Lₐ [8], [9], [11]. Variable nodes compute sums of the incident LLR vectors, so that the a posteriori values of information bits are

Lₚ(uᵢ)=Lₑ^{(det)}(uᵢ)+Lₑ^{(dec1)}(uᵢ)+Lₑ^{(dec2)(}uᵢ) (5).

For a decoding architecture with two factor nodes like in the case of Turbo decoding without iterative demapping, the order of factor node updates is clear: the two factors are updated in turn. For this case with three nodes, the order is arbitrary (which was pointed out in the context of iterative decoding of arbitrarily concatenated codes in [3], [12]). Based on the generic receiver architecture illustrated in FIG. 1, an actual receiver is described by its factor node update schedule.

The aim is to predict convergence of the described iterative receiver processing for any schedule. The approach is to track the conditional LLR distributions corresponding to the messages in FIG. 1 for all node updates. Receiver performance is then given by the mutual information (MI) between the Lₚ(u) and the transmit bits u:

$$I ( u , {L}_{p} ) = \sum \sum p ( {L}_{p} , u ) ln \frac{p ( {L}_{p} , u )}{{p}_{{L}_{p}} ( {L}_{p} ) \cdot {p}_{u} ( u )} , \qquad ( 6 )$$

where p(Lₚ, u) is the joint distribution, and pᵤ(u) and pLₚ(Lₚ ) are the marginal distributions. To evaluate the accuracy of the presented prediction method for concrete demapper/decoder schemes, the following common algorithms are picked: the constituent decoders perform log-APP decoding according to the BCJR algorithm [13], the MIMO demapper uses max-log-APP detection [1].

The extrinsic demapper LLRs are therefore [1]:

$${L}_{e}^{( Det )} ( {b}_{i} ) \approx {max}_{{x}^{( t )} ∈ {χ}_{i}^{+}} ( \begin{matrix}- \frac{1}{2 {σ}_{N}^{2}} {‖ {y}^{( t )} - {H}^{( t )} {x}^{( t )} ( {b}^{( t )} ) ‖}^{2} + \\ {\sum }_{n \neq i} min ( {b}_{n}^{( t )} {L}_{a}^{( Det )} ( {b}_{n}^{( t )} ) ; 0 )\end{matrix} ) - {max}_{{x}^{( t )} ∈ {χ}_{i}^{-}} ( - \frac{1}{2 {σ}_{N}^{2}} {‖ {y}^{( t )} - {H}^{( t )} {x}^{( t )} ( {b}^{( t )} ) ‖}^{2} + {\sum }_{n \neq i} min ( {b}_{n}^{( t )} {L}_{a}^{( Det )} ( {b}_{N}^{( t )} ) ; 0 ) ) \qquad ( 7 )$$

wherein Xᵢ⁺ is the set of all possible transmit vectors x^{(t)}, wherein the bit whose LLR is to be computed has the value +1. For the channel uncorrelated Rayleigh fading for each time instance t, and noise variance σ²_{N} is assumed. Three different schedules for which prediction accuracy is assessed are arbitrarily picked:
schedule 1: ‘normal’ receiver with Turbo decoder. First the demapper is updated once, then the constituent decoders are run alternatingly.
schedule 2: the demapper is run first, and then again always after four Turbo decoder iterations (eight constituent decoder updates).
schedule 3: ‘round-robin’ schedule. Demapper, decoder 1 and decoder 2 are run periodically in this order (demapper update after each Turbo decoder iteration).

For simulation 4×4 QPSK transmission, and channel coding with the 3GPP (Third Generation Partnership Project)LTE Turbo code (rate 1/3) is further assumed.

Shortcoming of 1-Parametic Gaussian Model

EXIT charts [2], [3] are based on a 1-parametric conditional

Gaussian distribution model of LLRs. This model is derived from the assumption of BPSK transmission over an AWGN channel:

y=x(b)+n (8)

Under this assumption the extrinsic LLRs generated by the demapper follow a (conditional) Gaussian distribution with the special property that the (conditional) absolute expectancy value is half of the (conditional) variance [2]:

$$\vert E ( {L}_{e}^{( det )} ( b ) \vert b ) \vert = \frac{1}{2} Var ( {L}_{e}^{( det )} ( b ) \vert b ) . \qquad ( 9 )$$

An LLR distribution is therefore completely described by one parameter, e.g. by the standard deviation σ. As consequence, there is a bidirectional mapping J: σ→I between this parameter and the mutual information carried by this distribution (MI of LLRs with the transmit bits, Eq. (6)). This mapping is the basis of EXIT charts [2]. EXIT charts assume that the 1-parametric distribution property is sustained after a

BCJR decoder. The parameter transfer I(Lₐ)→I(Lₑ) is tabularised in a table T, its graph is the EXIT curve. To track LLR density evolution for convergence prediction, I(Lₑ) can be looked up from this table for known I(Lₐ) for information bits and code bits:

Iₑ(b)=T(Iₐ(u), Iₐ(c)) (10)

The 1-parametric property (Eq. (9)) is also sustained for summation of LLRs, since mean and variance of the sum distribution are the sum of the means and variances, respectively. The MI of the LLR sum can therefore be determined by using J-1 and adding the variances [2]:

$${I}_{sum} ( u ) = J ( \sqrt{{\sum }_{i} {{J}^{- 1} ( {I}_{e}^{( i )} ( u ) )}^{2}} ) \qquad ( 11 )$$

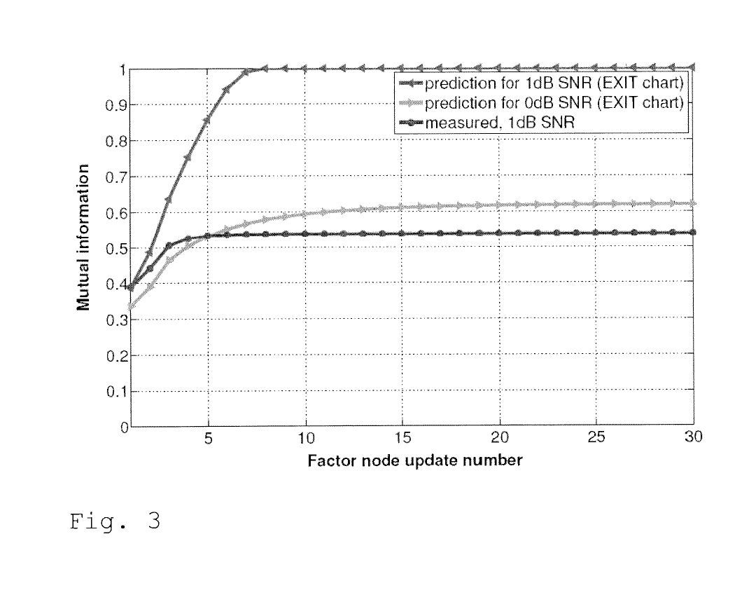

To see why this model is less favorable in this scenario, EXIT charts are applied to predict convergence of schedule 1 (‘normal’ receiver, no iterative demapping) for channel SNR of 1 dB. The prediction of MI after each factor node update is shown in FIG. 3. The Figure also shows the measured MI, which is obtained by Monte Carlo simulation of the complete receiver processing and non-parametric conditional LLR distribution estimation after each factor update number. While EXIT charts predict convergence after 8 node updates, measurement shows a saturation at MI of 0.53. An EXIT chart prediction for 0 dB channel SNR predicts saturation at higher MI than 0.53. The prediction error in this case is therefore larger than 1 dB, which is so large that it renders the prediction method useless.

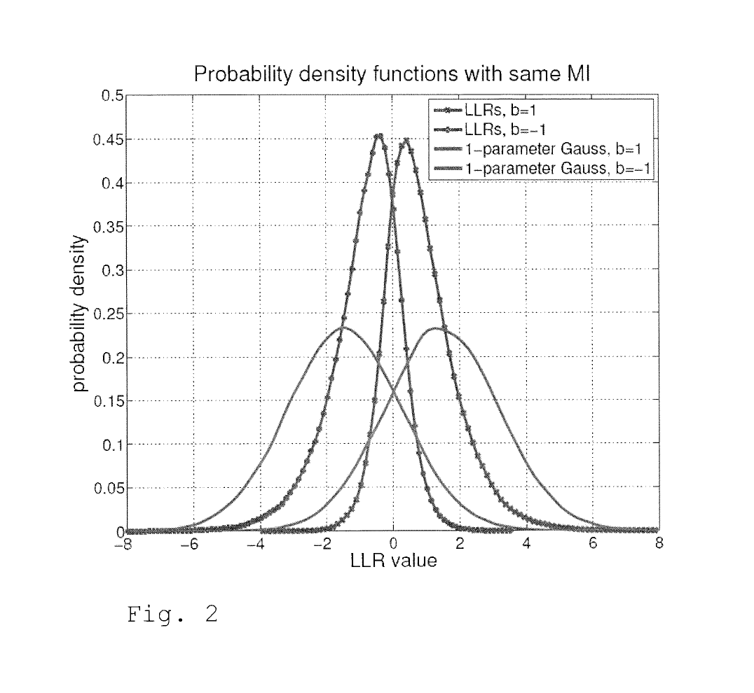

The misprediction is explained by the actual LLR distribution after the demapper (max-log-APP demapping [1], uncorrelated Rayleigh fading), which is shown in FIG. 2. While it does resemble a conditional Gaussian distribution, Eq. (9) is clearly violated: the mean value is not half the variance. FIG. 2 also shows a conditional Gaussian distribution with the same MI which satisfies Eq. (9) (mean and variance are different from the measured distribution). This is the curve which EXIT chart prediction assumes for this MI value, and it is the reason for the wrong prediction trend. The problem is not that the demapper or decoder EXIT curves would be wrong: histogram based measurement of the extrinsic MI as in [2] is indeed correct. The problematic 1-parametric fitting occurs when the output LLRs become input for the next factor node, because the EXIT curves are computed with 1-parametric input distributions.

Extended Gaussian Model: 2 Parameters

It is noted that while EXIT charts track the MI value corresponding to an LLR distribution, they could equivalently track a different parameter describing the 1-parametric Gaussian distribution, e.g. the standard deviation [7].

In the previous section the conclusion is drawn that the 1-parametric Gaussian model where the expectancy μ is half the variance σ² (Eq. (9)) is less adequate in this scenario. But it could still be the case that another 1-parametric model, maybe with a nonlinear relation between μ and σ², can be used. To test this, a Monte-Carlo simulation of the complete receiver processing according to schedule 3 (‘round robin’) is run, and μ and σ of the LLR distributions after each factor update number are measured. Looking at the value pairs of μ and σ, the result is that a 1-parametric description does not work.

Therefore one parameter is added to the model and in accordance with [7] it is assumed that the LLRs as conditionally Gaussian distributed with arbitrary mean μ and standard deviation σ, leaving out Eq. (9). Table look-ups for the extrinsic information transfer of decoders or demapper now have more dimensions: based on mean and standard deviation of the input distributions, the mean and standard deviation of the extrinsic output distribution are looked up. A decoder look-up becomes:

(μₑ)(b), σₑ(b))=T((μₐ(u), σₐ(u)); (μₐ(c), σₐ(c))) (12).

The MIMO demapper look-up in this scenario has six input values (three input vectors with two parameters each, compare FIG. 1). The mapping from distribution parameters (μ, σ) to MI (function J) now has one more dimension. MI of the Gaussian distribution is only determined by the ratio q=μ/σ of mean value and standard deviation, the corresponding bit error rate (for a posteriori LLRs) is given by the tail probability [7]:

BER=Q(q) (13).

As coordinates for the 2-dimensional mapping function mean value p, quotient q=μ/σ, and MI are therefore used:

$$J \text{:} ( μ , \frac{μ}{σ} ) ↦ I . \qquad ( 14 )$$

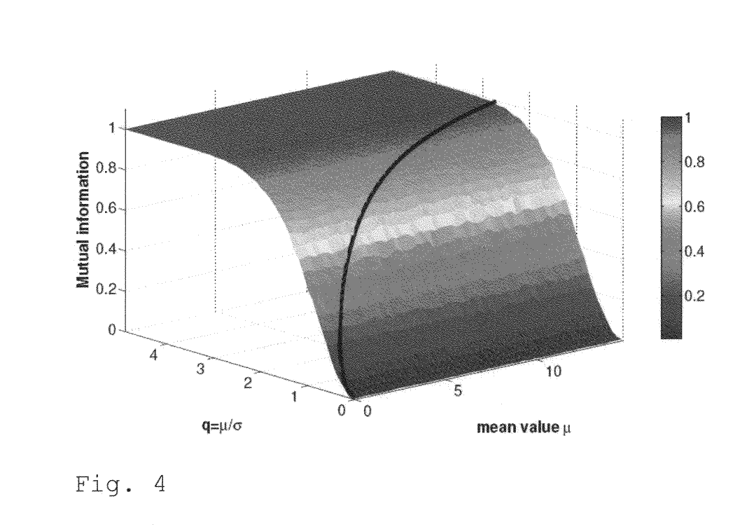

The function is illustrated in FIG. 4. The Figure also shows the curve for the 1-parametric case, embedded as special case in the MI surface.

A BER smaller than 10⁻⁴ corresponds to q>3.7. FIG. 4 therefore also shows the parameter range which has to be covered by the look-up tables. Since there are infinitely many Gaussian distributions with the same quotient q, the function J is no longer invertible. Due to this, the distributions are tracked for iterative decoding using only their Gaussian parameters μ and σ, the mapping to MI (or BER) is only necessary when the iterations are stopped. For a sum of LLRs, instead of Eq. (11) the following equation will be obtained:

$${μ}^{( sum )} ( u ) = {\sum }_{i} {μ}^{( i )} ( u ) \\ {σ}^{( sum )} ( u ) = \sqrt{{\sum }_{i} {( {σ}^{( i )} )}^{2}} \qquad ( 15 )$$

i.e. the sum is still (conditionally) Gaussian distributed.

Compensating Mutual Information Offset for Higher Order Moments of LLR Distribution

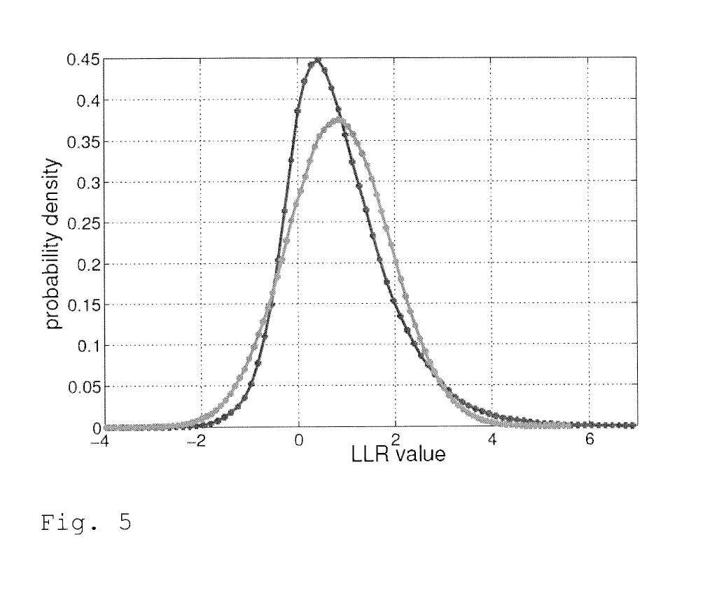

As expected, the more flexible 2-parametric model reproduces the actual MI evolution trend and yields better accuracy—but beginning from the first demapping, the prediction has an MI offset compared to the measured MI. This offset can be explained by the fact that the MIMO demapper LLRs do not exactly follow a Gaussian distribution: not all cumulants of the distribution for order larger than 2 are zero. This is illustrated in FIG. 5. The Figure shows the LLR distribution from the MIMO example as well as the Gaussian distribution which has the same mean and variance. The measured LLR distribution shows a nonzero skewness, it is not symmetric. MI of the assumed Gaussian distribution is smaller, causing the initial prediction offset. It is assumed that the Gaussian distribution can either have the same mean and variance as the real distribution, or the same MI—but not both.

For a consistent concatenation of table look-ups, the demapper table using the Gaussian distribution with same mean and variance as the real one is determined. To compensate the initial MI loss, it is also computed at table generation time. For one channel SNR value, the demapper table now is a mapping from 6 input dimensions to 3 output dimensions (compare FIG. 1):

(μₑ(b), σₑ(b), I_{offset})=T((μₐ(u), σₐ(u); (μₐ(c₁), σₐ(c₁)); (μₐ(c₂), σₐ(c₂))) (16).

Adding channel SNR as input dimension makes the demapper table input 7-dimensional. For the prediction results presented here, the input LLR distributions were sampled with 8 points per dimension (0≦μ≦15, 0≦q≦5), resulting in 260000 entries in the demapper table per channel SNR value. Using the fact that the roles of u, c₁ and c₂ are interchangeable for the demapper, only 46000 table entries have to be computed. The table for a constituent decoder was already described in the previous section (4 input dimensions to 2 output dimensions). Since the two constituent decoders are identical for the LTE Turbo codes which were used, they are both described by the same table. For table look-ups linear interpolation between neighbouring sample points are used.

The predicted Gaussian parameters (μₚ, σₚ) of the distribution of the a posteriori LLRs Lₚ(u) are then mapped to MI by table look-up (function J), and the I_{offset} value returned by the last demapper table look-up for Lₑ^{(det)}(b) is added:

$${I}_{predict} = J ( {μ}_{p} , \frac{{μ}_{p }}{{σ}_{p}} ) + {I}_{offset} . \qquad ( 17 )$$

Mutual Information Prediction Accuracy for Different Schedules

Verifying MI prediction accuracy by comparison with MI measurement, for the three receiver processing schedules have been described above. ‘Prediction’ uses the described concatenation of table look-ups, where the concatenation order of look-ups from the two tables is determined by the schedule. ‘Measurement’ performs Monte-Carlo simulation of the complete receiver and measures MI using nonparametric estimation of the joint distribution of a posteriori LLRs and transmit bits according to Eq. (6), independently for each schedule.

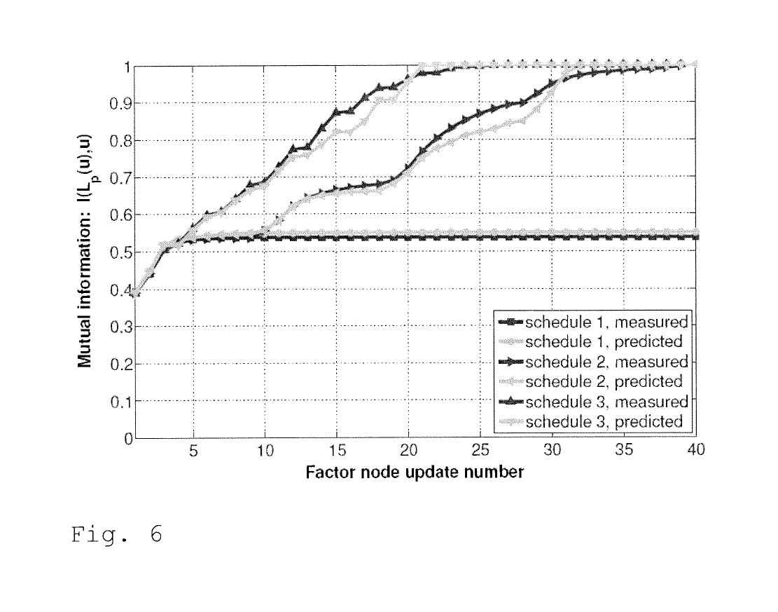

The results of prediction and measurement are shown in FIG. 6. Schedule 1 (‘normal’ receiver) does not converge for this low SNR level, which is now correctly predicted. The MI of a posteriori LLRs saturates after around 7 factor computations (6 constituent decoder updates) at 0.53. Schedule 2 converges after around 40 factor computations (including 5 demapper updates and 35 constituent decoder updates). A demapper update only brings a small MI improvement in itself, but afterwards decoder updates gain more again. Schedule 3 (‘round-robin’) converges already with around 25 factor computations.

All periodic schedules which include the same factors converge to the same MI limit value [3], since they completely use the same information sources. The maximum MI value which can be reached by the extrinsic MIMO demapper output Lₑ^{(det)} is that of SIMO maximum ratio combining for (shifted) BPSK modulation [14]: if the demapper a priori LLRs Lₐ^{(det)} have full MI (implying that the receiver algorithm has already converged), for each LLR to compute, all transmit bits of the MIMO vector are known except one, meaning that only two symbol constellation points remain. The MI prediction curves in FIG. 6 do show small deviations from the also shown measurement curves, which are due to higher order cumulants (order higher than 2) of LLR distributions and finite granularity of the look-up tables.

Verifying BER and Threshold Prediction

Prediction of the APP LLR distribution includes bit error rate (BER) prediction according to Eq. (13). To verify BER and SNR threshold prediction, this mapping from the LLR distribution to BER is applied for the two models and compared with measurement for very long packets. For the proposed method one obtains:

$$BER = Q ( \frac{{μ}_{p}}{{σ}_{p}} ) , \qquad ( 18 )$$

while for EXIT chart based prediction this reduces to one parameter:

$$BER = Q ( \sqrt{\frac{{μ}_{p}}{2}} ) . \qquad ( 19 )$$

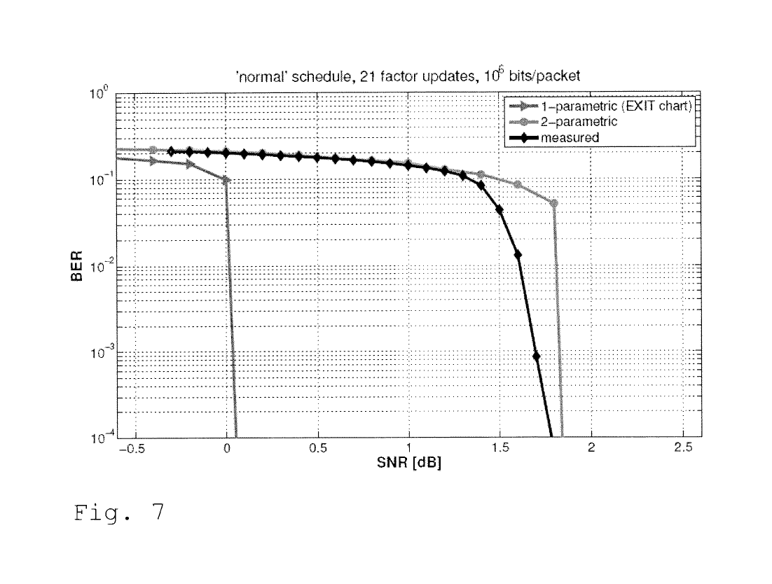

Prediction and measurement for varying SNR (for a fixed schedule) with focus on the SNR threshold required for a target BER like e.g. 10⁻⁴ are evaluated. FIG. 7 illustrates results for the ‘normal’ schedule with 21 factor updates. As implied by MI prediction (FIG. 3), EXIT charts predict the threshold for this schedule more than 1.5 dB too small, while the proposed method predicts it 0.1 dB too high. For BER prediction, no compensation is applied to the MI offset, as this would affect the complete BER curve and not only the BER threshold. MI offset causes the SNR threshold to be predicted too high.

As apparent from the above, EXIT charts in the normal way as applied to AWGN channels are not applicable to some practically relevant scenarios with fading MIMO channels. How well the underlying 1-parametric model fits the demapper LLR distribution depends on the demapper algorithm, modulation and MIMO fading distribution. This may explain why the results discussed here seem to differ from [6], where a ‘good match’ was found between simulation and EXIT chart based prediction in a different scenario.

The 2-parameter extension improves prediction performance by better fitting to the real LLR distribution. Together with offset compensation for higher order distribution moments it achieves satisfactory MI prediction accuracy. For non-Gaussian distributions a systematic error remains (higher order moments), so that prediction performance is less accurate than for AWGN channels. Prediction accuracy for other channel models—especially intersymbol interference (ISI) channels—has not been investigated. The proposed method is however applicable to MIMO-OFDM, as OFDM (orthogonal frequency division multiplexing) converts an ISI channel into a set of individually flat fading channels.

The higher dimensionality of the extended charts causes the charts to be less illustrative. Complexity of look-up table computation increases due to the higher dimensionality. On the other hand, computational effort is reduced a bit again by the parametric density estimation: estimating mean and variance is faster than estimating MI (with non-parametric density estimation like histograms or kernel methods). This could also be used for computation of normal EXIT charts, as it is also consistent with the 1-parametric model. In principle, the prediction accuracy can be improved by increasing the number of parameters used to describe LLR distributions: look-up tables could be extended to include higher order moments. This is limited in practice by the time necessary to compute the tables, the advantage of fast prediction compared to slow link-level simulation would erode.

The proposed prediction method may serve as a basis for receiver optimization at receiver design time (choice of algorithms and processing schedule). Comparing all receivers for the described scenario (three factor nodes) which have a schedule length of exactly 20 factor node updates (106 different receivers) may well be too much for link-level simulation based comparison. Using the proposed method, all of them can be compared after generating only two look-up tables. Comparison of different factor computation algorithms (especially demapper algorithm alternatives) can be done by changing the respective factor look-up table. A criterion for optimization can be the sum of computational cost for reaching the target MI (corresponding to a required packet error rate) at a certain SNR. The prediction accuracy of the proposed method is sufficient to reduce the receiver design space to a few interesting algorithm candidates, which can then be verified by more time-consuming link-level simulation.

Factorizing Joint Probability Density Function

MIMO transmission at time instance t over the channel matrix H^{(t)} can be denoted as

y^{(t)}=H^{(t)}·x^{(t)}(b^{(t)})+n^{(t)}. (20).

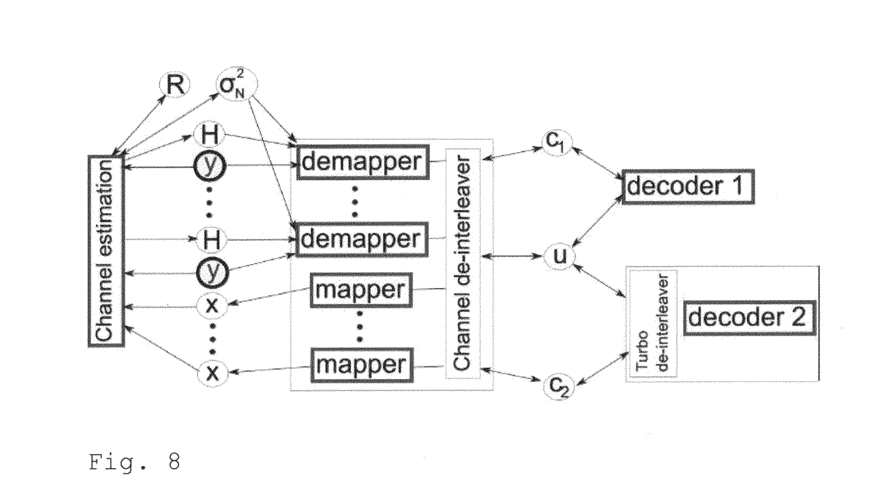

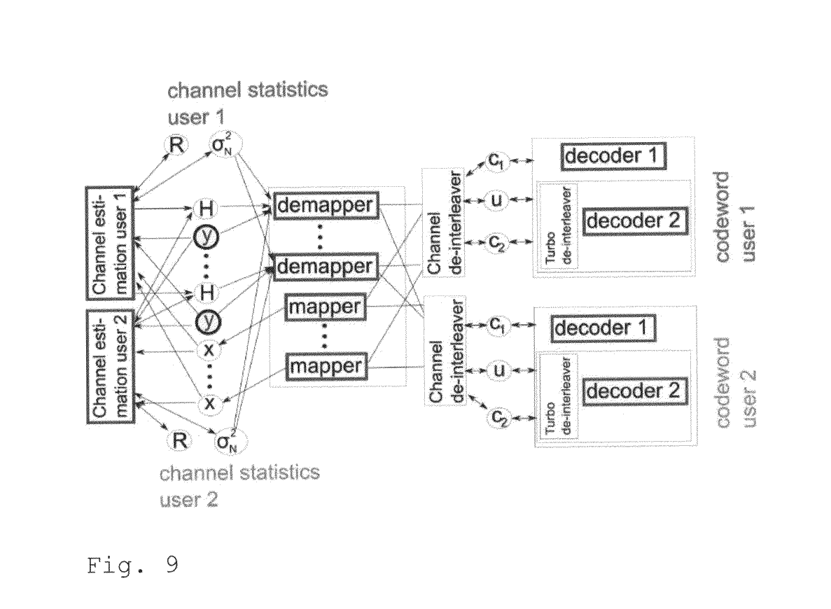

It can be assumed that the channel does not have memory, which can also be considered as subcarrier model in MIMO-OFDM transmission. b^{(t)} is a vector of transmit bits as part of the complete codeword b, x^{(t)} is the corresponding vector of modulated symbols. The complete set of received symbol values of the message (all time instances) is denoted y. The transmitter uses Turbo coding, so that the code word b consists of the information bits u, parity bits c₁ of the first constituent encoder and parity bits c₂ of the second constituent encoder. bᵢ is written for a single bit of the bit vector b at position i. FIGS. 8 and 9 illustrate the encoding and modulation signal flow at the transmitter (without channel estimation).

Maximum receiver performance would be reached if computing the maximum likelihood solution on codeword basis:

$$\hat{u} = arg {max}_{u} P ( u \vert y ) . \qquad ( 21 )$$

As this is practically infeasible, the practical approach is an iterative local approximation of the information bit APPs with subsequent binary quantization. The joint probability density can be factorized:

$$P ( u , y ) = ( {\prod }_{t} {f}_{Dem} ( {b}^{( t )} , {y}^{( t )} , {H}^{( t )} ) ) \cdot {f}_{Dec 1} ( u , {c}_{1} ) \cdot {f}_{Dec 2} ( u , {c}_{2} ) \cdot \cdot {f}_{CE} ( y , x ) \cdot ( {\prod }_{t} {f}_{Map} ( {b}^{( t )} ) ) \qquad ( 22 )$$

which corresponds to a detector for each different time instance, the two constituent decoders, a soft symbol mapper for each time instance and channel estimation (for all symbol positions of the codeword). The received vectors y are ‘evidence’.

The complete factor graph including channel estimation is shown in FIG. 9. This section describes the update of factor nodes and variable nodes from FIG. 8 and specifies the messages passed between them according to Belief propagation. Usage of a factor graph for visualization does not mean that only optimal and complex a posteriori probability computation by an algorithm is considered. The method is also applied for suboptimal algorithms which approximate the a posteriori probability with less complexity.

FIG. 8 shows a factor graph of joint probability density. Variable nodes are circles, factor nodes are squares. ‘Evidence’ y is shaded. All variable nodes are vectors, H^{(t)} are matrices.

FIG. 9 further shows joint MIMO demapping and separate decoding for MU-MIMO in an exemplary fashion.

The blocks called ‘Channel estimation’, ‘mapper’, ‘demapper’, ‘decoder’, and ‘decoder 2’ in FIGS. 8 and 9 form predefined models of algorithms in order to model the receiver. Each predefined model is capable of mapping at least one input probability density to at least one output probability density. As such, the blocks allow inputting an input probability density, which has been determined based on a predefined signal-to-noise ratio, to a sequence of model algorithms, and determining the output probability density at the output of the sequence of model algorithms in order to determine the bit-error rate of the receiver for the respective sequence of model algorithms.

Optimization Criteria

The task is an optimal distribution of algorithms to a number of homogeneous multiprocessor cores, where the number of cores as well as the update schedules and algorithm components for each factor update are flexible. For given a transmission mode (modulation, MIMO scheme and code rate) and channel characteristics, receiver processing quality can be described by operational SNR (SNR: signal-to-noise ratio, wherein the SNR is minimal where reception works with predefined error rate), receiver complexity and processing delay. In the 3-dimensional (complexity, target SNR, processing delay) pareto-optimal receiver algorithm space, the following optimization criteria could be chosen (among any other weighted combinations):

1. Minimum operational SNR for fixed complexity. Which receiver algorithm satisfies the operational requirements with minimum computational effort? The answer to this question could be used to choose adequate hardware, e.g. the number of processor cores, clock speed or width of parallel processing (single instruction multiple data, SIMD).

2. Minimum complexity for fixed target hardware. Given a fixed hardware with certain computational power, what are the achievable operating conditions (and with which algorithm can this be reached)?

3. Minimum delay for fixed operational SNR. How far can the processing delay be reduced by parallelizing node updated schedules using different cores? Differing from the serial schedule which was used so far, processing is described by a parallel schedule.

Receiver Algorithm Description Language

To describe node update schedules, where different algorithms for each update are possible, a description language may be used which is explained in an exemplary fashion hereinafter. The language preferably has a regular grammar and can thus be parsed by a finite state automation (Chomsky hierarchy type 3 language). A receiver then corresponds to a path through the finite state algorithm.

Factor Graph Notation: Directed Bipartite Graph

A factor graph F is given by the sets of its vertices (nodes) and directed edges F=V, E, with the property that the graph is bipartite: the set of nodes consists of two disjoint subsets, where every edge is between nodes belonging to different sets. For the factor graph describing the generic receiver architecture, the first node subset comprises the factor nodes:

V₁={ce, dem, dec1, dec2, map} (23).

The used node abbreviations may be listed in a table together with the corresponding factor node and the factor node type. The second subset comprises the variable nodes:

V₂={u, c₁, c₂, y, H}. (24)

The complete set of nodes in this case is:

V=V₁∪V₂ (25).

The general set of edges E⊂V×V with the bipartite graph property is

E=E₁∪E₂; with E₁⊂V₁×V₂, E₂⊂V₂×V₁ (26)

where the adjacency matrix can be described as:

$$A = ( \begin{matrix}0 & {A}_{1} \\ {A}_{2} & 0\end{matrix} ) . \qquad ( 27 )$$

In the receiver graph case the edges are:

E={(y, ce), (x, ce), (H, dem), (y, dem), (u, dec1), (c₁ , dec1), (u, dec2), (c₂, dec2), (u, map), (c₁, map), (c₁, map), (ce, H), (map, x), (dem, u), (dem, c₁), (dem, c2), (dec1, u), (dec1, c₁), (28)

| Factor node | Type | Abbreviation |
|---|---|---|
| Channel estimation | channel estimation | ce |
| MIMO demapper | demapping | dem |
| Constituent decoder 1 | decoding | dec1 |
| Constituent decoder 2 | decoding | dec2 |
| Soft Mapper | mapping | map |

Algorithm Notation

After naming the factor nodes, now the mapping of an algorithm to a node will be described. The considered algorithms may be listed in a table, together with algorithm type and abbreviation. The set of algorithm abbreviations for the example list is

A={wif, snd, ummse, hummse-ml (m=m), bcjr} (29).

To map an algorithm to a factor node, the abbreviations of node and algorithm are concatenated. Algorithm and factor node should have the same type (e.g. the BCJR algorithm is not applicable for channel estimation).

The set of valid algorithm mappings to factor nodes is the alphabet E (set of symbols) of the receiver description language:

Σ={(v_{—}a)|v ε V₁, a ε A, factor node v and algorithm a have same type} (30)

### EXAMPLES

ce_wif: channel estimation using Wiener interpolation filter.

dem_hummse-ml (m=8): MIMO demapping using the hybrid unbiased MMSE/max-log-APP algorithm with parameter m=8.

dec2_bcjr: constituent decoder 2 implementing the BCJR algorithm.

| Algorithm | Type | Abbreviation |
|---|---|---|
| Wiener interpolation filter | channel estimation | wif |
| 2nd order model CE | channel estimation | snd |
| unbiased MMSE | demapping | ummse |
| hybrid uMMSE/max-log-APP, | demapping | hummse-ml |
| m LLRs linear | | (m = m) |
| BCJR | decoding | bcjr |

Schedule Notation: Regular Expression

A schedule is a valid word from the regular receiver description language L. The language can be defined by a starting set of valid words and ‘construction rules’.

Starting Set:

[symbol] (θ): ‘empty’ receiver is in [symbol] .

$${∀}_{s ∈ \sum } ( s ) = s \text{:}$$

only one factor node update

Construction Rules:

$${∀}_{s . t . ∈ \sum } ( s \vert t ) = ( s ) ⋃ ( t ) \text{:} alternative \\ ( st ) = \{ α β \vert α ∈ ( s ) ⋀ β ∈ ( t ) \} \text{:} sequence \\ ( {a}^{*} ) = {⋃}_{i \geq 0} {i}^{} ( a ) \text{:} repetition \\ ( {a}^{+} ) = {⋃}_{i \geq 1} {i}^{} ( a ) \text{:} nonzero repetition ( at least once )$$

A receiver design space (search space) is a subset [symbol] ⊂ [symbol] and can be given as a regular expression. Examples:

Rₙₒᵣₘₐₗ=(ce wif dem ummse) (dec1 bcjr dec2 bcjr)* describes a ‘normal’ linear receiver with turbo decoder (at least one turbo decoder iteration).

Rᵢₜₑᵣₐₜᵢᵥₑ₋₁=(ce wif) (dem ummse|dem max log|dec1 bcjr|dec2 bcjr)* describes a receiver with possibly iterative demapping

decoding allowing free concatenation of four demapping/decoding components.

Automatic Receiver Optimization

Complexity Measure

The complexity of an algorithm may be given by the amount and type of its elementary operations, which is an implementation-independent measure. The computational cost on a certain hardware (like processor or coprocessor) is evaluated by counting the theoretically necessary cycles to perform the operations (in an optimal implementation).

The algorithm complexity vs. implementation complexity (hardware independent/dependent) may be benchmarked vs. theoretical upper limit (optimal utilization).

For a hardware independent assessment of complexities the elementary operations of the considered signal processing blocks are counted: for example for the candidate algorithms ZF and MMSE detector, M-detector and Turbo decoder. While ZF/MMSE use multiply-accumulate (MAC) operations, and table look-ups (LU) for the soft demodulator (for LTE-like modulation possible because of separable I/Q components), the M-detector uses MAC and Select (SEL, conditional move) operations. For the sorting step of the M-detector the bubblesort algorithm is assumed, because it is suited for SIMD parallel implementation. The turbo decoder uses Add-Compare-Select (ACS) operations for trellis traversal and Compare-Select (CS) operations for LLR reconstruction.

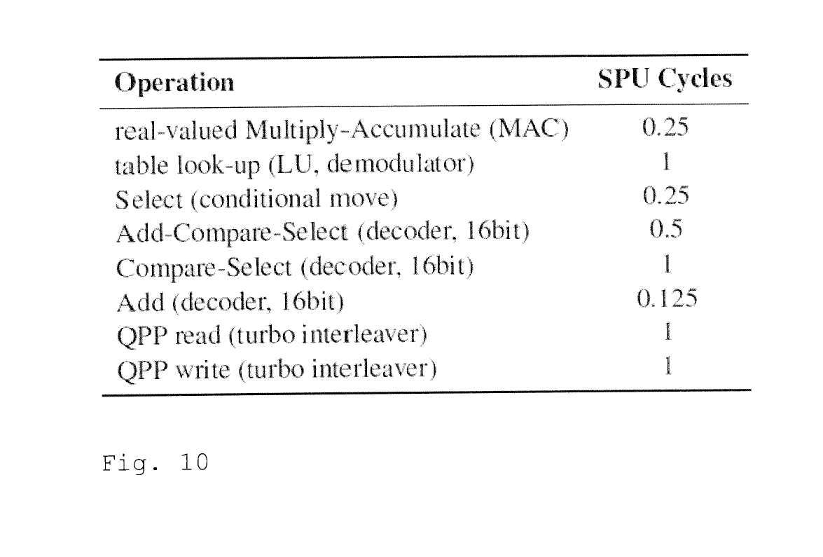

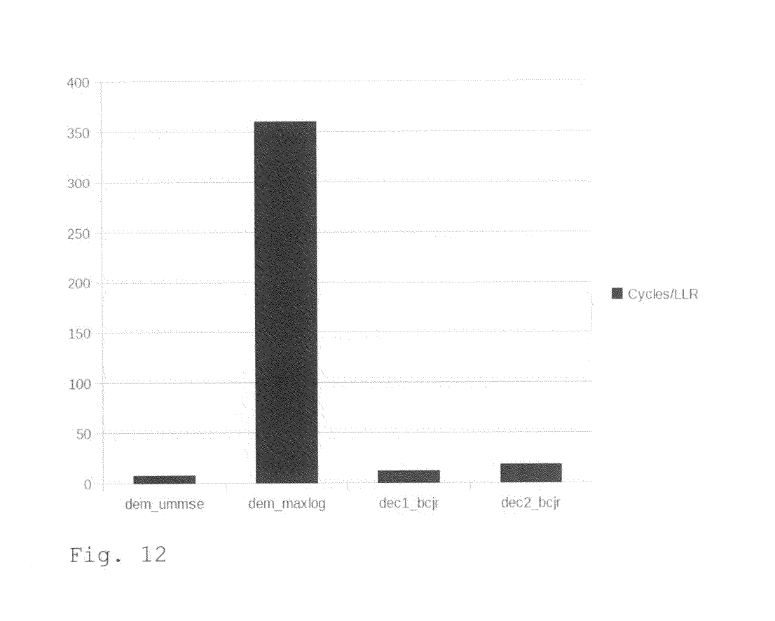

To enable comparison and joint optimization, the complexities and different operations may be expressed in a common cost metric. This is a hardware dependent mapping. Theoretically achievable cycles on the target hardware are counted. The numbers of operations per cycle on the SPU using SIMD parallel implementation are given in the table shown in FIG. 10. It would also be possible to choose implementation benchmarks instead of theoretically achievable cycle count. Load/store operations can be done in parallel to arithmetic operations (different processor pipelines) for all blocks except the turbo interleaver, where they are preferably counted explicitly. The resulting block complexities measured in cycles/LLR are illustrated in FIG. 12 for QPSK.

The SPU has been chosen as target hardware due to its general-purpose signal processing architecture and high performance. It is used in an SDR (software defined radio) testbed, which give implementation benchmarks and discuss how close an actual implementation with reasonable programming effort (C-language using vector intrinsics) can reach the theoretical cycle count.

Operational SNR Versus Receiver Complexity

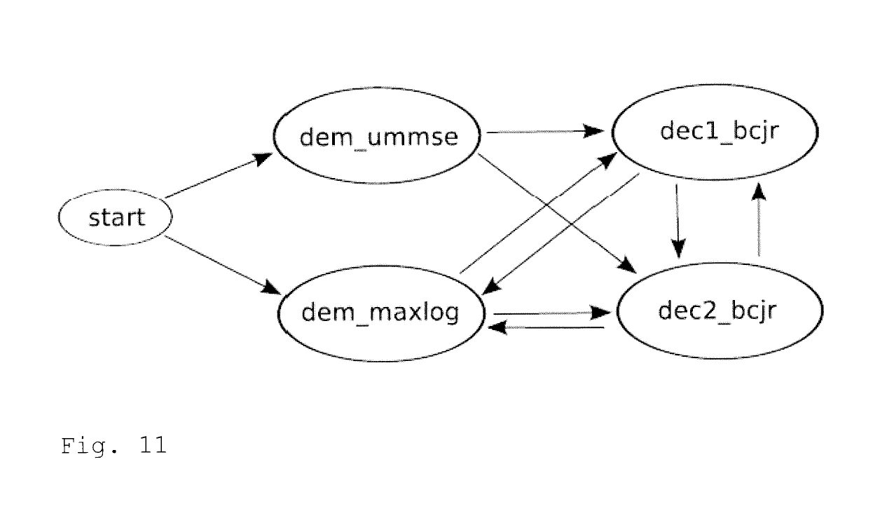

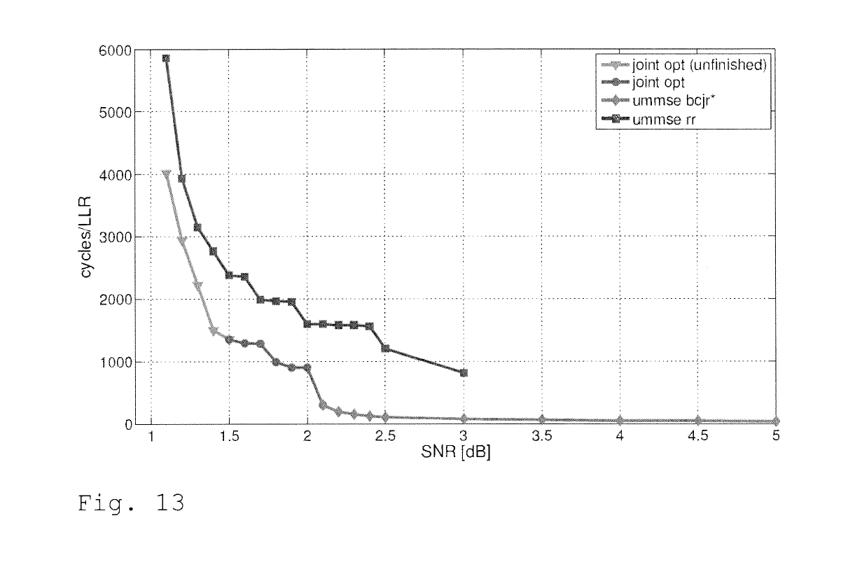

FIG. 11 shows an example search graph specifying the receiver design space (without channel estimation). FIG. 12 shows a computational effort of the considered signal processing blocks on Cell SPU. FIG. 13 shows results for 4×4 QPSK.

For any receiver specified as sequence of signal processing blocks the performance can now be estimated (as MI at target SNR), and the computational effort can be obtained by summing up the blocks' cycles/LLR.

A search space of considered receiver architectures may be specified as directed graph (state transition graph) of signal processing blocks, alternatively to a description according to the receiver description language. The optimal receiver algorithm combination (among the set of receivers specified by the graph) is the one satisfying the operational requirements (target MI at target SNR) with minimal cycle count. It is found by graph search, where each state can be an end state. An example graph is given in FIG. 11.

1. Method of determining an optimum sequence of algorithms, each algorithm defining a receiver function of a receiver, which has a plurality of receiver functions and which is adapted to receive bits sent by a transmitter, the method comprising the steps of:
(a) for each receiver function, picking an algorithm out of a predefined group of algorithms available for the respective receiver function, and virtually combining predefined models of the picked algorithms in order to model the receiver, wherein each predefined model is capable of mapping at least one input probability density to at least one output probability density, and wherein said combined models form a sequence of model algorithms;
(b) determining an input probability density based on a predefined signal-to-noise ratio, said input probability density indicating the probability density of values received by the receiver at the predefined signal-to-noise ratio;
(c) inputting the input probability density to said sequence of model algorithms;
(d) determining the output probability density at the output of said sequence of model algorithms, said output probability density indicating the bit density of the bits sent by the transmitter;
(e) determining the bit-error rate of the receiver for said sequence of model algorithms based on said output probability density;
(f) repeating steps (a)-(e) for all algorithms comprised by said predefined groups of algorithms for all receiver functions; and
(g) determining the optimum sequence of algorithms taking the bit-error rates of the sequences of model algorithms into account.

2. Method according to claim 1:
wherein a total receiver complexity value is determined by adding algorithm complexity values of all algorithms picked in step(a); and
wherein in step (g), the total receiver complexity values of the picked algorithms are taken into account for determining the optimum set of algorithms.

3. Method according to claim 1
wherein the algorithms picked in step (a) are combined to generate a preliminary sequence of algorithms; and
wherein a delay time is determined for each preliminary sequence of algorithms; and
wherein in step (g) the step of determining the optimum set of algorithms further takes the delay time of each preliminary sequence of algorithms into account.

4. Method according to claim 1
wherein a set of signal-to-noise ratios is predefined; and
wherein steps (a)-(g) are repeated for all signal-to-noise ratios of said set of signal-to-noise ratios; and
wherein the optimum sequence of algorithms is determined taking at least the signal-to-noise ratios and the respective bit-error rates into account.

5. Method according to claim 1 wherein groups of algorithms are taken into account for at least one of the following receiver functions: decoding, mapping, demapping, and channel estimation.

6. Method according to claim 1 wherein
forming said sequence of model algorithms may include combing the model algorithms in a parallel and/or a serial fashion.

7. Method according to claim 1 wherein
the input and output probability densities are each defined by a mean value and a variance of a 2-parametric Gaussian density function.

8. Method according to claim 1 wherein
the model of at least one algorithm of at least one receiver function accounts for MIMO reception.

9. Method according to claim 8 wherein
the model of at least one demapping algorithm, at least one channel estimation algorithm, and/or at least one mapping algorithm accounts for MIMO reception.

10. Method according to claim 1 wherein
an individual name is assigned to each possible combination of receiver function and algorithm/algorithm model.

11. Method according to claim 10 wherein
the sequence of model algorithms is defined by a vector comprising the names as vector elements.

12. Method according to claim 11 wherein
the search for determining the optimum sequence is based on said vectors.

13. Method according to claim 12 wherein
each name forms a word of a description language.

14. Method according to claim 13 wherein
the description language is regular.

15. Method according to claim 14 wherein
the search space for determining the optimum sequence of algorithms is defined by a plurality of operations applied to the names and/or vectors.

16. Method according to claim 1 wherein the optimum sequence of algorithms is determined taking at least two transmitters or codewords into account;
wherein an individual signal-to-noise ratio is assigned to each transmitter or codeword and
wherein at least one receiver function considers the individual input densities of the at least two transmitters or codewords and
wherein bit error rates are determined from the output densities either as average for the transmitters or codewords or separately.

17. Method for manufacturing a receiver wherein
an optimum sequence of algorithms is determined according to claim 1;
the algorithms of the optimum sequence are assigned to one or more processors; and
the algorithms of the optimum sequence are implemented in receiver hardware and/or receiver software.

18. Method according to claim 17 wherein
wherein a total receiver delay time value is determined based on the processing times of the algorithms picked in step(a) during processing by said one or more processors; and
wherein in step (g), the total receiver delay time value resulting from the picked algorithms are taken into account for determining the optimum set of algorithms.
